(19) United States
(12) Patent Application Publication
(10) Pub. No.: US 2012/0141918 A1
(43) Pub. Date: Jun. 7, 2012

(54) FUEL SUPPLY APPARATUS, FUEL CARTRIDGE, AND JOINT

(76) Inventors: Isamu KAWATA, Osaka (JP); Masaki MITSUI, Kyoto (JP); Junya KUSUMOTO, Nara (JP)

(21) Appl. No.: 13/307,639

(22) Filed: Nov. 30, 2011

(30) Foreign Application Priority Data
Dec. 3, 2010 (JP) 2010-270817

(51) Int. Cl. H01M 8/04; H01M 8/02

(52) U.S. Cl. 429/507; 429/515

(57) ABSTRACT

A fuel supply apparatus for supplying a liquid fuel to a device having a fuel cell which uses the liquid fuel is provided. The fuel supply apparatus includes: a container containing the liquid fuel and being configured to be detachably attached to the device; and a joint for connecting the container and the device. The joint has a double tube structure including an outer tube and an inner tube. One of the outer tube and the inner tube forms a flow path through which the liquid fuel in the container flows into the device by gravity, while the other tube forms a flow path through which a replacement fluid spontaneously flows into the container to replace the liquid fuel.

### FIELD OF THE INVENTION

This invention relates to a fuel supply apparatus for supplying a liquid fuel to a device including a fuel cell, a fuel cartridge for the fuel supply apparatus, and a joint for connecting the fuel cartridge and the device.

### BACKGROUND OF THE INVENTION

Recently, electronic devices have become rapidly portable and cordless. There is thus demand for development of secondary batteries that are small and light-weight and have high energy density as the power source for such electronic devices. However, when secondary batteries are used as the power source for such devices, they need to be charged. Also, the time for which secondary batteries can supply power to devices on a single charge is limited by their capacity. As such, fuel cells, which can supply power to devices stably for a long time if only they get refueled, are receiving attention as the power source therefore.

Among fuel cells, direct oxidation fuel cells (DOFCs) generate power by directly oxidizing a fuel that is in liquid form at room temperature without reforming it. Therefore, DOFCs need no reformer and can be easily made small. Further, direct methanol fuel cells (DMFCs), which use methanol as the fuel, are superior in energy efficiency and power generation output to other direct oxidation fuel cells, thus being regarded as the most promising among DOFCs.

However, methanol is harmful to humans. Thus, when methanol is supplied as the fuel to a device including a fuel cell, it is necessary to take measures for preventing the fuel from spilling or evaporating in large amounts in the air. Therefore, it is desirable to supply the fuel, for example, by attaching a fuel cartridge containing the fuel to the device, and resupplying the fuel, as necessary, from the fuel cartridge to the fuel tank or the like built in the device.

Further, the joint for connecting the fuel cartridge and the device desirably has a structure which prevents the fuel from leaking to outside.

Patent Document 1 (Japanese Laid-Open Patent Publication No. 2006-017269) and Patent Document 2 (Japanese Laid-Open Patent Publication No. 2007-073464) propose examples of such joints.

However, in the case of portable electronic devices, it is particularly difficult to make the diameter of the joint sufficiently large. If the diameter of the joint is small, it is difficult to allow the fuel to flow spontaneously from the fuel cartridge into the device. Thus, the joints of Patent Documents 1 and 2 do not have a structure in which the fuel spontaneously flows into the tank of the device from the fuel cartridge. They have, for example, a structure in which the fuel is injected into the tank of the device by pressing the container of the fuel cartridge with the hand or fingers. That is, the joints of Patent Documents 1 and 2 are not designed for fuel cartridges which are attached to devices while the devices are in use so that the fuel is resupplied to the devices as the fuel is consumed by the devices.

However, containers for highly inflammable fuels, such as methanol, need to have high resistance to pressure and impact, and thus, they are usually made of hard, rigid resins, not soft resins. As a result, children or elderly persons may find it difficult to press such containers with their fingers. Also, the amount of fuel which can be supplied by pressing the rigid resin container once with the fingers is slight. Therefore, in the case of devices that consume relatively large amounts of power and consume large amounts of fuel, the fuel supply operation can be very troublesome. As such, there is demand for development of a fuel cartridge which is attached to a device while the device is in use so that the fuel can be smoothly resupplied to the device (including a portable power generator) having a fuel cell as the fuel is consumed by the device.

It is therefore an object of the invention to provide a fuel supply apparatus capable of smoothly supplying a liquid fuel to a device having a fuel cell, a fuel cartridge therefore which is attached to the device while the device is in use, and a joint for connecting the device and the fuel cartridge.

### BRIEF SUMMARY OF THE INVENTION

One aspect of the invention relates to a fuel supply apparatus for supplying a liquid fuel to a device having a fuel cell which uses the liquid fuel. The fuel supply apparatus includes: a container containing the liquid fuel and being configured to be detachably attached to the device; and a joint for connecting the container and the device. The joint has a double tube structure including an outer tube and an inner tube. One of the outer tube and the inner tube forms a flow path through which the liquid fuel in the container flows into the device by gravity, while the other tube forms a flow path through which a replacement fluid spontaneously flows into the container to replace the liquid fuel. The fuel supply apparatus of the invention can be configured so that the fuel is resupplied to the device as the fuel is consumed by the fuel cell.

Another aspect of the invention relates to a fuel cartridge configured to be detachably attached to a device having a fuel cell which uses a liquid fuel. The fuel cartridge includes: a container containing the liquid fuel; and a connector for connecting the container to the device. The connector has a double tube structure including an outer tube and an inner tube. One of the outer tube and the inner tube forms a flow path through which the liquid fuel in the container flows into the device by gravity, while the other tube forms a flow path through which a replacement fluid spontaneously flows into the container to replace the liquid fuel.

Still another aspect of the invention relates to a device including: a fuel cell which uses a liquid fuel; a fuel tank; and a connector for connecting the fuel tank to a fuel cartridge containing the liquid fuel. The connector has a double tube structure including an outer tube and an inner tube. One of the outer tube and the inner tube forms a flow path through which the liquid fuel in the fuel cartridge flows into the fuel tank by gravity, while the other tube forms a flow path through which a replacement fluid spontaneously flows into the fuel cartridge to replace the liquid fuel.

Still another aspect of the invention relates to a joint for connecting a device having a fuel cell which uses a liquid fuel and a fuel cartridge containing the liquid fuel. The joint has a double tube structure including an outer tube and an inner tube. One of the outer tube and the inner tube forms a flow path through which the liquid fuel in the fuel cartridge flows into the device by gravity, while the other tube forms a flow path through which a replacement fluid spontaneously flows into the fuel cartridge to replace the liquid fuel.

According to the invention, a liquid fuel can be smoothly supplied to a device having a fuel cell from a fuel cartridge which is attached to the device while the device is in use.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a schematic sectional view of a fuel supply apparatus according to one embodiment of the invention;

FIG. 2 is a schematic sectional view of one of a pair of connectors of a joint included in the fuel supply apparatus;

FIG. 3 is a schematic sectional view of the other connector of the joint;

FIG. 4 is a schematic sectional view of the pair of connectors joined together;

FIG. 5 is a sectional view schematically showing the structure of a unit cell as an example of fuel cells; and

FIG. 6 is a schematic sectional view of a joint in another embodiment of the invention.

### DETAILED DESCRIPTION OF THE INVENTION

The invention relates to a fuel supply apparatus for supplying a liquid fuel to a device having a fuel cell which uses the liquid fuel. The fuel supply apparatus includes: a container containing the liquid fuel and being configured to be detachably attached to the device; and a joint for connecting the container and the device. The joint has a double tube structure including an outer tube and an inner tube.

One of the outer tube and the inner tube forms a flow path through which the liquid fuel in the container flows into the device by gravity, while the other tube forms a flow path through which a replacement fluid spontaneously flows into the container to replace the liquid fuel.

In the case of small devices, in particular, the joint for connecting, for example, a fuel cartridge and a built-in tank of a small device tends to have a small diameter to prevent leakage of the fuel from the container. When the diameter of the joint is small, the diameter of the fuel flow path also becomes small, and thus, the flow path tends to be occupied by only the fuel. As a result, it is difficult to allow the fuel to spontaneously flow into the built-in tank from the fuel cartridge by replacing the fuel in the fuel cartridge with the air in the built-in tank of the device. Therefore, in conventional fuel cartridges of this kind, the container of the fuel cartridge is pressed with the fingers to inject the fuel into the built-in tank of the device. That is, in the case of conventional fuel cartridges for devices having a structure in which the diameter of the joint cannot be enlarged so much, only “temporary-use type” fuel cartridges, which are temporarily used to inject the fuel to the tanks of the devices, have been put into practical use.

In the apparatus of the invention, by providing the joint with a double tube structure including an outer tube and an inner tube, a flow path for a replacement fluid, such as air, is formed in the joint independently of the fuel flow path. Therefore, even when the size of the joint is small, it is possible to supply the fuel smoothly by replacing the liquid fuel in the fuel cartridge with air or the like. As such, by simply connecting the fuel cartridge to a device including a fuel cell by means of the joint of the invention, it is possible to supply the fuel to the device continuously by gravity as the fuel is consumed by the device.

As a result, there is no need to perform a fuel supply operation which would be necessary when using a temporary-use type fuel cartridge, and the operation of supplying the fuel to the fuel cell can be made simple. Therefore, the convenience for users is improved. In particular, in the case of devices which consume relatively large amounts of power and consequently consume large amounts of fuel, the convenience for users is significantly improved. Further, since there is no need to enlarge the size of the joint in order to allow the fuel to spontaneously flow into the device, the size of the joint, fuel cartridge, and fuel supply apparatus including these can be easily reduced. Thus, the size of the device including the fuel cell can be easily reduced.

Also, even in the case of medium-size or large-size devices, by forming a replacement fluid flow path in the joint independently of the fuel flow path, the fuel can be supplied more smoothly, compared with conventional ones. Therefore, the invention is also applicable advantageously to fuel supply apparatuses for medium-size and large-size devices. Examples of medium-size and large-size devices include power generators for home use, power generators having larger capacity than those for home use, power generators for construction work, electric scooters, and mobility scooters for the elderly. Examples of small-size devices include notebook personal computers and wireless speakers.

It is preferable that the flow path for the liquid fuel be the space between the outer tube and the inner tube, and that the flow path for the replacement fluid be the space inside the inner tube. In this case, the area of the flow path for the liquid fuel having a higher viscosity than that of the replacement fluid such as air can be easily enlarged. Thus, the fuel can be supplied smoothly.

The smallest inner diameter of the outer tube is preferably 5 to 15 mm. By setting the smallest inner diameter of the outer tube to 15 mm or less, it is possible to prevent the joint from becoming large. Hence, it becomes easy to reduce the size of the fuel supply apparatus and therefore the device including the joint. Also, by setting the smallest inner diameter of the outer tube to 5 mm or more, smooth supply of the fuel is ensured. Also, the smallest inner diameter of the inner tube is preferably 2 to 4 mm. In the case of a fuel cartridge which is attached to a device while the device is in use, when the amount of fuel consumed by the device is small, the amount of fuel to be supplied to the device from the fuel cartridge per unit time becomes small commensurately. Therefore, when the amount of power consumed by the device is small, even if the smallest value of the diameter within the above-mentioned range is selected, the amount of fuel supplied per unit time becomes sufficient.

The smallest inner diameter of the outer tube is more preferably 5 to 10 mm. When the smallest inner diameter of the outer tube is in this range, it is difficult to supply the fuel smoothly to the device by utilizing gravity alone, unless the joint is provided with a double tube structure. Therefore, the invention is more effective when the inner diameter of the outer tube is in the above range.

The smallest difference between the inner diameter of the outer tube and the outer diameter of the inner tube is preferably 1 to 5 mm. By setting the smallest difference to 5 mm or less, it becomes easy to reduce the size of the joint and therefore the size of the fuel supply apparatus and the device. Also, by setting the difference to 1 mm or more, smooth supply of the fuel can be ensured.

Further, the joint of the apparatus of the invention can be composed of a first connector for the fuel cartridge (container) and a second connector for the device. By joining the first connector and the second connector, the fuel cartridge and the device are connected.

Further, the outer tube and the inner tube can be divided between the first connector and the second connector. That is, each of the outer tube and the inner tube can be divided in two parts, so that one of the divided parts of the outer tube and one of the divided parts of the inner tube form the first connector for the container, while the other divided part of the outer tube and the other divided part of the inner tube form the second connector for the device. In this embodiment, each of the first connector and the second connector has an outer tube and an inner tube (a first divided part of the outer tube, a second divided part of the outer tube, a first divided part of the inner tube, and a second divided part of the inner tube). By joining the outer tube (the first divided part of the outer tube) and the inner tube (the first divided part of the inner tube) of the first connector to the outer tube (the second divided part of the outer tube) and the inner tube (the second divided part of the inner tube) of the second connector, respectively, a flow path for the liquid fuel and a flow path for the replacement fluid are completed. Alternatively, it is also possible to provide only one of the first connector and the second connector with a double tube structure including an outer tube and an inner tube, while providing the other connector with a single tube structure.

It is necessary to provide a mechanism or the like that prevents the fuel in the cartridge from leaking from the first connector when the first connector for the fuel cartridge and the second connector for the device are not joined. As such a mechanism, when the first connector has a double tube structure, it is preferable to make the inner tube (e.g., the first divided part of the inner tube) of the first connector movable in the axial direction relative to the outer tube (e.g., the first divided part of the outer tube) and provide the first connector with a first valve mechanism that opens and closes the outer tube of the first connector by movement of the inner tube.

More specifically, the first valve mechanism can be realized by forming a valve seat near the tip of the outer tube, and providing the inner tube with a valve for closing a valve hole and a biasing means (elastic body) for biasing the valve toward the valve seat. When the first connector and the second connector are not joined, the valve is pressed over the valve seat by the biasing force exerted by the biasing means, so that the valve hole is closed. As a result, the outer tube is closed. On the other hand, when the first connector and the second connector are joined, the inner tube of the first connector comes into contact with a predetermined part of the second connector (e.g., the tip of the inner tube of the second connector). As a result, the inner tube is moved against the biasing force exerted by the biasing means in such a manner that the valve comes apart from the valve seat. By this, the outer tube is opened.

The first connector may further include a second valve mechanism. The second valve mechanism includes a first valve rod that is inserted in the inner tube in such a manner that it is movable in the axial direction of the inner tube (e.g., the first divided part of the inner tube), and opens and closes the inner tube of the first connector by movement of the first valve rod. The second valve mechanism may also include the above-mentioned biasing means or the like.

Likewise, when the second connector has a double tube structure, it is preferable to make the inner tube (e.g., the second divided part of the inner tube) of the second connector movable in the axial direction relative to the outer tube (e.g., the second divided part of the outer tube) and provide the second connector with a third valve mechanism that opens and closes the outer tube of the second connector by movement of the inner tube. The third valve mechanism may also include the above-mentioned biasing means or the like.

Likewise, the second connector may further include a fourth valve mechanism. The fourth valve mechanism includes a second valve rod that is inserted in the inner tube in such a manner that it is movable in the axial direction of the inner tube (e.g., the second divided part of the inner tube), and opens and closes the inner tube of the second connector by movement of the second valve rod. The fourth valve mechanism may also include the above-mentioned biasing means or the like.

By providing the first connector and the second connector with the above-described valve mechanisms, immediately after the first connector and the second connector which are joined together are separated, the openings of the respective connectors can be closed and sealed. It should be noted that when one of the first and second connectors does not have a double tube structure, the connector without a double tube structure cannot be provided with the above-described valve mechanisms. Thus, it is difficult to close and seal the opening of that connector immediately after the joined first and second connectors are separated. Therefore, it is preferable to provide each of the first and second connectors with a double tube structure to provide each connector with the above-described mechanisms.

Further, in a preferable embodiment of the apparatus of the invention, the flow path for the liquid fuel is the space between the outer tube and the inner tube while the flow path for the replacement fluid is the space inside the inner tube, and when the first connector and the second connector are joined, the inlet of the inner tube of the second connector for the replacement fluid protrudes from the outlet of the outer tube of the second connector for the liquid fuel. The position of the inlet of the inner tube for the replacement fluid included in the second connector for the device defines the highest level of the liquid fuel in the built-in tank of the device when the liquid fuel is supplied by gravity. That is, in this embodiment, when the liquid level in the built-in tank reaches the inlet of the inner tube, the spontaneous flow of the fuel from the fuel cartridge into the built-in tank stops. Therefore, by causing the position of the inlet of the inner tube of the second connector to protrude from the outlet of the outer tube of the second connector, for example, when an air vent is formed in an upper part (e.g., the top wall) of the built-in tank, the highest liquid level in the built-in tank can be easily set so that the fuel does not leak from the air vent.

The invention also relates to a fuel cartridge configured to be detachably attached to a device having a fuel cell which uses a liquid fuel. The fuel cartridge includes: a container containing the liquid fuel; and a first connector for a joint, which comprises the first connector and a second connector, for connecting the container to the device. The joint or first connector has a double tube structure including an outer tube and an inner tube. One of the outer tube and the inner tube forms a flow path through which the liquid fuel in the container flows into the device by gravity, while the other tube forms a flow path through which a replacement fluid spontaneously flows into the container to replace the liquid fuel.

Further, the invention relates to a device including: a fuel cell which uses a liquid fuel; a fuel tank connected to the fuel cell; and a connector (second connector) for connecting the fuel tank to a fuel cartridge containing the liquid fuel and being configured to be attached to the device while the device is in use. When the connector is jointed to the connector (the first connector or a connector having a single tube structure) of the fuel cartridge, a joint is formed. The second connector has a double tube structure including an outer tube (e.g., the second divided part of the outer tube) and an inner tube (e.g., the second divided part of the inner tube). One of the outer tube and the inner tube forms a flow path through which the liquid fuel in the fuel cartridge flows into the fuel tank by gravity, while the other tube forms a flow path through which a replacement fluid spontaneously flows into the fuel cartridge to replace the liquid fuel.

Further, the invention relates to a joint for connecting a device having a fuel cell which uses a liquid fuel and a fuel cartridge containing the liquid fuel. The joint has a double tube structure including an outer tube and an inner tube. One of the outer tube and the inner tube forms a flow path through which the liquid fuel in the fuel cartridge flows into the device by gravity, while the other tube forms a flow path through which a replacement fluid spontaneously flows into the fuel cartridge to replace the liquid fuel.

An embodiment of the invention is hereinafter described with reference to drawings.

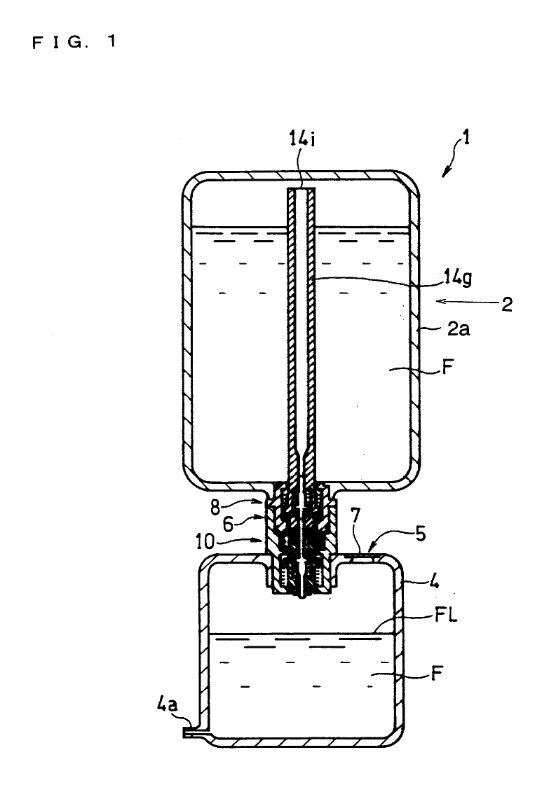

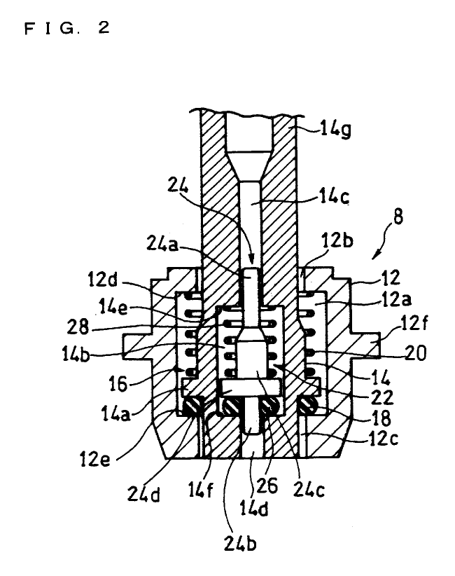

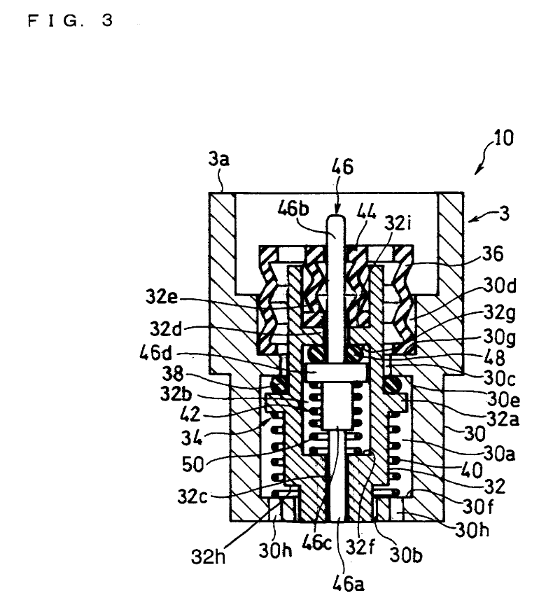

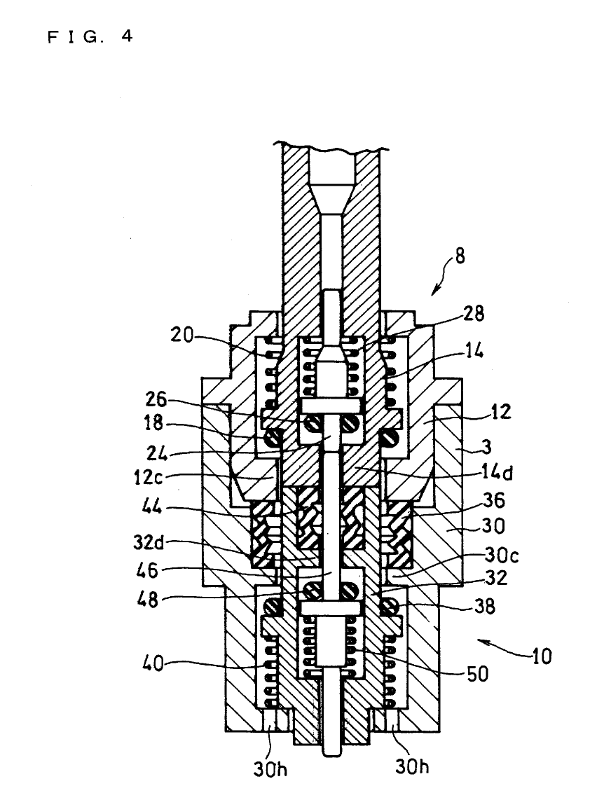

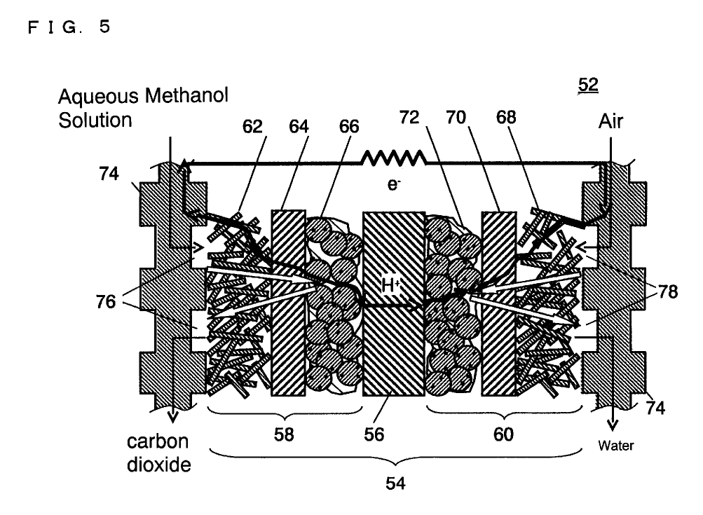

FIG. 1 is a schematic sectional view of a fuel supply apparatus according to one embodiment of the invention. FIG. 2 is a schematic sectional view of one of a pair of connectors of a joint included in the fuel supply apparatus. FIG. 3 is a schematic sectional view of the other connector. FIG. 4 is a schematic sectional view of the joint when the pair of connectors is joined together. FIG. 5 is a schematic sectional view of the structure of a unit cell which forms a fuel cell.

As illustrated in FIG. 1, a fuel supply apparatus 1 includes a fuel cartridge 2 for containing a liquid fuel, and a joint 6 for connecting the fuel cartridge 2 and a built-in tank 4 of a device. The joint 6 includes a connector 8 (first connector) for the fuel cartridge 2 and a connector 10 (second connector) for the device. The fuel cartridge 2 includes a container 2a for containing the fuel and the connector 8. At the bottom of the built-in tank 4, there is a fuel supply pipe 4a, which is connected to a fuel pump (not shown) for supplying the fuel to a fuel cell.

As illustrated in FIG. 2, the connector 8 for the fuel cartridge 2 has an outer tube 12 (e.g., a first divided part of the outer tube) through which the liquid fuel in the container 2a flows into the built-in tank 4 by gravity and an inner tube 14 (e.g., a first divided part of the inner tube) through which air (replacement fluid) spontaneously flows into the container 2a from the built-in tank 4 to replace the liquid fuel. The outer tube 12 and the inner tube 14 are cylindrical and coaxial. At least a part of the inner tube 14 is inserted into the outer tube 12 in such a manner that it is movable in the axial direction relative to the outer tube 12 fixed to the container 2a. Alternatively, it is also possible for the outer tube 12 to form the flow path for the replacement fluid, and for the inner tube 14 to form the flow path for the liquid fuel.

The wall of each of the outer tube 12 and the inner tube 14 is preferably made of a molded resin in terms of weight reduction. In particular, resin materials having good chemical resistance to liquid fuels are desirable. When the fuel is methanol, polyethylene (PE), polypropylene (PP), polyether ether ketone (PEEK), polyphenylene sulfide (PPS), polyethylene terephthalate (PET), etc. are preferable.

The outer tube 12 includes a valve containing portion 12a, a spring receiving portion 12b, and a valve hole portion 12c. The valve containing portion 12a is a large-diameter portion containing a valve mechanism 16 for opening and closing the outer tube 12. The spring receiving portion 12b is a small-diameter portion which is adjacent to and on one side of the valve containing portion 12a (the container 2a side, or the upper side in the figure). The valve hole portion 12c is a small-diameter portion which is adjacent to and on the other side of the valve containing portion 12a (the tip side of the connector 8). For example, the inner diameter of the valve hole portion 12c is the smallest inner diameter of the outer tube 12. At the border between the valve containing portion 12a and the spring receiving portion 12b or the valve hole portion 12c, there is a step in the inner face. Thus, at the border therebetween, there is an annular end face 12d or 12e perpendicular to the axial direction of the outer tube 12.

Further, the outer face of the outer tube 12 has an annular protrusion 12f which is rectangular in cross-section. The connector 8 is joined to the connector 10 for the device by inserting the tip of the connector 8 into the connector 10. The protrusion 12f is provided at a predetermined distance from the tip of the outer tube 12 in order to define the depth of insertion of the connector 8 into the connector 10.

The valve mechanism 16 includes: an annular protrusion 14a (valve) which is rectangular in cross-section and is formed on the outer face of the inner tube 14; a packing 18 such as an O-ring; and an elastic body 20 such as a coil spring. The packing 18 is fitted onto the inner tube 14 so that it contacts the face of the protrusion 14a on the valve hole portion 12c side (the tip side of the inner tube 14).

The elastic body 20 is compressed in the valve containing portion 12a so that it biases the inner tube 14 toward the tip side of the connector 8. More specifically, one end of the elastic body 20 in the directions of stretching and contraction is in contact with the face of the protrusion 14a opposite to the face in contact with the packing 18, while the other end of the elastic body 20 is in contact with the end face 12d at the border between the spring receiving portion 12b and the valve containing portion 12a.

Because the inner tube 14 is biased toward the tip side of the connector 8 by the elastic body 20, the packing 18 comes into contact with the end face 12e (valve seat) at the border between the valve hole portion 12c and the valve containing portion 12a. As a result, the valve hole portion 12c at the tip of the outer tube 12 is closed, so that the outer tube 12 is closed. The tip (valve hole portion 14d) of the inner tube 14 comes into contact with the tip of an inner tube 32 of the connector 10 (described below) when the connector 8 is joined to the connector 10. As a result, the inner tube 14 moves against the biasing force exerted by the elastic body 20 in such a manner that the packing 18 comes apart from the end face 12e. As a result, the outer tube 12 is opened.

Next, the inner tube 14 is described. The inner tube 14 also includes a valve containing portion 14b, a spring receiving portion 14c, and a valve hole portion 14d. The valve containing portion 14b is a large-diameter portion containing a valve mechanism 22 for opening and closing the inner tube 14. The spring receiving portion 14c is a small-diameter portion which is adjacent to and on one side of the valve containing portion 14b (on the container 2a side). The valve hole portion 12d is a small-diameter portion which is adjacent to and on the other side of the valve containing portion 14b (the tip side of the connector 8).

For example, the inner diameter of the valve hole portion 14d is the smallest inner diameter of the inner tube 14. The difference between the inner diameter of the valve hole portion 12c and the outer diameter of the valve hole portion 14d is the smallest difference between the inner diameter of the outer tube and the outer diameter of the inner tube. At the border between the valve containing portion 14b and the spring receiving portion 14c or the valve hole portion 14d, there is a step in the inner face. Thus, at the border therebetween, there is an annular end face 14e or 14f perpendicular to the axial direction of the connector 8.

Further, a conduit 14g extends from the spring receiving portion 14c to introduce the replacement fluid to above the level of the liquid fuel in the container 2a (see FIG. 1). The open end of the conduit 14g can be covered with a gas-liquid separating film 14i. The gas-liquid separating film 14i is preferably made of a water-repellent material.

Since such a film allows a gas to pass through while not allowing a liquid to pass through, it can prevent the liquid fuel F from entering the conduit 14g and prevent the conduit 14g from being clogged with the liquid fuel F. As such, the replacement fluid (e.g., air) in the built-in tank 4 can be smoothly introduced into the container 2a. The gas-liquid separating film 14i can be made of, for example, a sheet prepared by melting particles of polytetrafluoroethylene (PTFE).

Further, by providing the upper part (e.g., top wall) of the built-in tank 4 with an opening (air vent) 5 for introducing the replacement fluid and covering the air vent 5 with a gas-liquid separating film 7, it is possible to prevent the fuel F from leaking from the air vent 5 while constantly keeping the inner pressure of the built-in tank 4 at atmospheric pressure. Thus, the liquid fuel F can be supplied smoothly by gravity. The gas-liquid separating film 7 can be made of the same material as that of the gas-liquid separating film 14i.

The valve mechanism 22 includes: a valve rod 24 disposed in the outer tube 12 in such a manner that its axial direction agrees with the outer tube 12; a packing 26 such as an O-ring; and an elastic body 28 such as a coil spring. The valve rod 24 includes: a small-diameter portion 24a inserted into the spring receiving portion 14c; a small-diameter portion 24b inserted into the valve hole portion 14d; and a large-diameter portion 24c between the small-diameter portion 24a and the small-diameter portion 24b. The outer face of the end of the large-diameter portion 24c on the small-diameter portion 24b side has an annular protrusion 24d (valve) which is rectangular in cross section. The packing 26 is fitted onto the small-diameter portion 24b so that it contacts the protrusion 24d.

The elastic body 28 is compressed in the valve containing portion 14b so that it biases the valve rod 24 toward the tip side of the connector 8. More specifically, one end of the elastic body 28 in the directions of stretching and contraction is in contact with the face of the protrusion 24d opposite to the face in contact with the packing 26, while the other end is in contact with the end face 14e at the border between the valve containing portion 14b and the spring receiving portion 14c.

Because the valve rod 24 is biased toward the valve hole portion 14d by the elastic body 28, the packing 26 comes into contact with the end face 14f (valve seat) at the border between the valve hole portion 14d and the valve containing portion 14b, thereby closing the valve hole portion 14d. As a result, the inner tube 14 is closed. When the connector 8 is joined to the connector 10, the small-diameter portion 24b of the valve rod 24 comes into contact with the tip (small-diameter portion 46b) of a valve rod 46 of the connector 10. As a result, the valve rod 24 moves against the biasing force exerted by the elastic body 28 in such a manner that the packing 26 comes apart from the end face 14f. As a result, the inner tube 12 is opened.

Next, referring to FIG. 3, the connector 10 for the device is described. The connector 10 also has an outer tube 30 (e.g., a second divided part of the outer tube) through which the liquid fuel in the container 2a flows into the built-in tank 4 and an inner tube 32 (e.g., a second divided part of the inner tube) through which air (replacement fluid) flows into the container 2a from the built-in tank 4, just like the connector 8. The outer tube 30 and the inner tube 32 are cylindrical and coaxial. The inner tube 32 is inserted into the outer tube 30 in such a manner that it is movable in the axial direction relative to the outer tube 30 fixed to the built-in tank 4. Alternatively, it is also possible for the outer tube 30 to form the flow path for the replacement fluid, and for the inner tube 32 to form the flow path for the liquid fuel.

Further, the connector 10 has a fitting portion 3 which fits with the tip of the connector 8 (outer tube 12). The fitting portion 3 is a cylinder having a larger inner diameter than the outer tube 30 and extending continuously from the outer tube 30. A tip 3a of the fitting portion 3 comes into contact with the protrusion 12f of the connector 8 to define the depth of insertion of the connector 8 into the fitting portion 3.

The outer tube 30 includes a valve containing portion 30a, a spring receiving portion 30b, a valve hole portion 30c, and a gasket containing portion 30d. The valve containing portion 30a is a large-diameter portion containing a valve mechanism 34 for opening and closing the outer tube 30. The spring receiving portion 30b is a small-diameter portion which is adjacent to and on one side of the valve containing portion 30a (the built-in tank 4 side, or the lower side in the figure). The valve hole portion 30c is a small-diameter portion which is adjacent to and on the other side of the valve containing portion 30a (the tip side of the connector 10). The gasket containing portion 30d is a large-diameter portion which is adjacent to the valve hole portion 30c and on the tip side of the connector 10 (fitting portion 3 side).

At the border between the valve containing portion 30a and the spring receiving portion 30b or the valve hole portion 30c, there is a step in the inner face. Thus, at the border therebetween, there is an annular end face 30e or 30f perpendicular to the axial direction of the connector 10. Further, at the border between the valve hole portion 30c and the gasket containing portion 30d, there is also a step in the inner face. Thus, at the border therebetween, there is an annular end face 30g perpendicular to the axial direction of the connector 10.

The gasket containing portion 30d contains a cylindrical gasket 36 which stretches and contracts like an accordion. The axial direction of the gasket 36 is substantially parallel to the axial direction of the outer tube 30, and one end of the gasket 36 is in contact with the end face 30g at the border between the valve hole portion 30c and the gasket containing portion 30d. A part of the inner tube 32 is inserted into the gasket 36.

The valve mechanism 34 includes an annular protrusion 32a (valve) which is rectangular in cross-section and is formed on the outer face of the inner tube 32, a packing 38, and an elastic body 40. The packing 38 is fitted onto the inner tube 32 so that it contacts the face of the protrusion 32a on the valve hole portion 30c side.

The elastic body 40 is compressed in the valve containing portion 30a so that it biases the inner tube 32 toward the tip side of the connector 10. More specifically, one end of the elastic body 40 in the directions of stretching and contraction is in contact with the face of the protrusion 32a opposite to the face in contact with the packing 38, while the other end of the elastic body 40 is in contact with the end face 30f at the border between the spring receiving portion 30b and the valve containing portion 30a.

Because the inner tube 32 is biased toward the tip side of the connector 10 (the fitting portion 3 side) by the elastic body 40, the packing 38 comes into contact with the end face 30e (valve seat) at the border between the valve hole portion 30c and the valve containing portion 30a, thereby closing the valve hole portion 30c. As a result, the outer tube 30 is closed. Also, when the inner tube 32 moves against the biasing force exerted by the elastic body 40 in such a manner that the packing 38 comes apart from the end face 30e, the outer tube 30 is opened.

Further, when the inner tube 32 moves against the biasing force exerted by the elastic body 40, the end face 30f at the border between the valve containing portion 30a and the spring receiving portion 30b comes into contact with an end face 32h formed by a step in the outer face of the inner tube 32, thereby functioning as a stopper to stop the inner tube 32 from moving any further. When the end face 32h is in contact with the end face 30f, the gap between the spring receiving portion 30b and the outer face of the inner tube 32 is closed (see FIG. 4). Therefore, the spring receiving portion 30b is provided with a plurality of through-holes 30h parallel to the axial direction of the outer tube 30. The liquid fuel F passes through these through-holes 30h.

Herein, it is also possible to form a protrusion (not shown) at a suitable position on the inner face of the valve containing portion 30a, so that when the inner tube 32 moves in such a direction that the packing 38 comes apart from the end face 30e, the protrusion comes into contact with the protrusion 32a, thereby preventing the end face 32h from coming into contact with the end face 30f. In this case, the liquid fuel F can be flown via the spring receiving portion 30b without forming the through-holes 30h in the spring receiving portion 30b.

Next, the inner tube 32 is described. The inner tube 32 includes a valve containing portion 32b, a spring receiving portion 32c, a valve hole portion 32d, and a gasket containing portion 32e. The valve containing portion 32b is a large-diameter portion containing a valve mechanism 42 for opening and closing the inner tube 32. The spring receiving portion 32c is a small-diameter portion which is adjacent to and on one side of the valve containing portion 32b (the lower side in the figure). The valve hole portion 32d is a small-diameter portion which is adjacent to and on the other side of the valve containing portion 32b (the tip side of the connector 10). The gasket containing portion 32e is a large-diameter portion which is adjacent to the valve hole portion 32d on the tip side of the connector 10.

At the border between the valve containing portion 32b and the spring receiving portion 32c or the valve hole portion 32d, there is a step in the inner face. Thus, at the border therebetween, there is an annular end face 32f or 32g perpendicular to the axial direction of the connector 10. Further, at the border between the valve hole portion 32d and the gasket containing portion 32e, there is also a step in the inner face. Thus, at the border therebetween, there is an annular end face 32i perpendicular to the axial direction of the connector 10.

The gasket containing portion 32e contains a cylindrical gasket 44 which stretches and contracts like an accordion. The axial direction of the gasket 44 is substantially parallel to the axial direction of the inner tube 32, and one end of the gasket 44 is in contact with the end face 32i at the border between the valve hole portion 32d and the gasket containing portion 32e.

The valve mechanism 42 includes a valve rod 46 which is disposed in the inner tube 32 in such a manner that its axial direction agrees with the inner tube 32, a packing 48, and an elastic body 50. The valve rod 46 includes a small-diameter portion 46a inserted into the spring receiving portion 32c, a small-diameter portion 46b inserted into the valve hole portion 32d, and a large-diameter portion 46c between the small-diameter portion 46a and the small-diameter portion 46b. The outer face of the end of the large-diameter portion 46c on the small-diameter portion 46b side has an annular protrusion 46d (valve) which is rectangular in cross section. The packing 48 is fitted onto the small-diameter portion 46b so that it contacts the protrusion 46d.

The elastic body 50 is compressed in the valve containing portion 32b so that it biases the valve rod 46 toward the tip side of the connector 10. More specifically, one end of the elastic body 50 in the directions of stretching and contraction is in contact with the face of the protrusion 46d opposite to the face in contact with the packing 48, while the other end is in contact with the end face 32f at the border between the valve containing portion 32b and the spring receiving portion 32c.

Because the valve rod 46 is biased toward the tip side of the connector 10 by the elastic body 50, the packing 50 comes into contact with the end face 32g (valve seat) at the border between the valve hole portion 32d and the valve containing portion 32b, thereby closing the valve hole portion 32d. As a result, the inner tube 32 is closed. The tip of the small-diameter portion 46b of the valve rod 46 comes into contact with the tip of the valve rod 26 of the connector 8 when the connector 10 is joined to the connector 8. As a result, the valve rod 46 moves against the biasing force exerted by the elastic body 50 in such a manner that the packing 48 comes apart from the end face 32g. As a result, the inner tube 32 is opened.

With respect to the relationship between the elastic forces of the elastic bodies 20, 28, 40, and 50, it is preferable that the elastic force (coefficient of elasticity) of the elastic body 20 be greater than that of the elastic body 40 and that the elastic force of the elastic body 28 be greater than that of the elastic body 50. By setting the elastic forces of the respective elastic bodies in this manner, when the connectors are joined, the valve mechanisms (34 and 42) of the connector for the device are opened first, and then the valve mechanisms (16 and 22) of the connector for the fuel cartridge 2 are opened. Therefore, when the fuel cartridge 2 is attached to the device, it is possible to prevent leakage of the fuel. Also, when the fuel cartridge 2 is detached from the device, the valve mechanisms (16 and 22) of the connector for the fuel cartridge 2 are closed first. Therefore, leakage of the fuel is prevented.

The packings and gaskets are preferably made of elastic materials such as various rubbers and elastomers. The valve rods and elastic bodies (coil springs) are preferably made of metal materials. As these materials, it is desirable to select materials which have good chemical resistance to the fuel (methanol) and from which residue or metal cations or the like do not leach upon contact with the fuel.

FIG. 4 illustrates the respective connectors joined together. In the illustrated state, the tip of the connector 8 fits with the fitting portion 3 of the connector 10. At this time, the inner tubes 14 and 32 come into mutual contact with each other, so that the inner tubes 14 and 32 move in the axial direction against the biasing forces exerted by the elastic bodies 20 and 40. As a result, the outer tube 12 and the outer tube 30 communicate with each other.

Also, the valve rods 24 and 46 come into mutual contact with each other, and move in the axial direction against the biasing forces exerted by the elastic bodies 28 and 50. As a result, the inner tube 14 and the inner tube 32 communicate with each other.

At this time, the tip of the gasket 36 comes into contact with the tip of the outer tube 12, thereby preventing leakage of the fuel. Also, the tip of the gasket 44 comes into contact with the tip of the inner tube 14, thereby preventing the liquid fuel F and the replacement fluid from mixing together in the flow path.

When the liquid fuel level FL (see FIG. 1) in the built-in tank 4 reaches the tip of the inner tube 32 due to supply of the liquid fuel F to the built-in tank 4 from the fuel cartridge 2, the inner tube 32, which is the flow path for the replacement fluid, is closed by the liquid fuel F, so that the flow of the replacement fluid from the built-in tank 4 into the container 2a is stopped. As a result, the supply of the liquid fuel F by gravity stops automatically.

The liquid fuel F in the built-in tank 4 is sucked from the built-in tank 4 by a fuel pump (now shown) connected to the fuel supply pipe 4a, transported to the fuel cell, and consumed for power generation. When the liquid fuel level FL lowers due to the consumption of the fuel, the inner tube 32 is reopened, so that the flow of the replacement fluid into the container 2a is resumed and the supply of the liquid fuel by gravity is automatically resumed.

Next, referring to FIG. 5, an example of the fuel cell is described. A direct oxidation fuel cell such as a direct methanol fuel cell is usually composed of stacked unit cells which are shaped like plates or sheets. The stacked unit cells are called a cell stack. Each unit cell is a fuel cell. The fuel cell can be composed only of one unit cell.

A unit cell 52 includes a membrane electrode assembly (MEA) 54 where power is generated. The MEA 54 has a layered structure in which a sheet-like anode 58 is bonded to one face of an electrolyte membrane 56 while a sheet-like cathode 60 is bonded to the other face of the electrolyte membrane 56.

The anode 58 includes an anode diffusion layer 62, an anode microporous layer (MPL) 64, and an anode catalyst layer 66. The anode catalyst layer 66 is in contact with the electrolyte membrane 56, and the anode MPL 64 is laminated on the anode catalyst layer 66. The anode diffusion layer 62 is laminated on the anode MPL 64.

Likewise, the cathode 60 includes a cathode diffusion layer 68, a cathode microporous layer (MPL) 70, and a cathode catalyst layer 72. The cathode catalyst layer 72 is in contact with the electrolyte membrane 56, and the cathode MPL 70 is laminated on the cathode catalyst layer 72. The cathode diffusion layer 68 is laminated on the cathode MPL 70.

When the fuel cell is a cell stack of the unit cells 52, the MEAs 54 of the unit cells 52 are stacked with conductive, plate-like separators 74 therebetween. The face of each separator 74 in contact with the anode diffusion layer 62 has a fuel supply channel 76 for supplying a fuel to the anode 58. The face of the separator 74 in contact with the cathode diffusion layer 68 has an oxidant supply channel 78 for supplying an oxidant to the cathode 60. The supply channels 76 and 78 can be produced by, for example, forming grooves in the respective faces of the separator 74.

Further, of both ends of the cell stack in the stacking direction of the unit cells 52, the end with the anode 58 positioned outward in the stacking direction can be fitted with a separator 74 having only the fuel supply channel 76 in one face so that the one face is in contact with the anode 58. This separator 74 is electrically connected with the negative terminal of the fuel cell.

The end with the cathode 60 positioned outward in the stacking direction can be fitted with a separator 74 having only the oxidant supply channel 78 in one face so that the one face is in contact with the cathode 60. This separator 74 is electrically connected with the positive terminal of the fuel cell. The outer sides of these separators 74 at both ends of the cell stack in the stacking direction of the unit cells 52 can be fitted with end plates (not shown).

Further, when the fuel cell includes only one unit cell 52, a separator 74 having only the fuel supply channel 76 in one face can be disposed so that the one face is in contact with the anode 58. Likewise, a separator 74 having only the oxidant supply channel 78 in one face can be disposed so that the one face is in contact with the cathode 60. Further, the outer sides of these separators 74 can be fitted with end plates (not shown).

The anode 58 is supplied with an aqueous solution containing methanol as the fuel via the fuel supply channel 76, while the cathode 60 is supplied with air containing oxygen as the oxidant via the oxidant supply channel 78. The methanol and water vapor derived from the aqueous methanol solution supplied to the anode diffuse in the plane direction of the anode diffusion layer 62, pass through the anode MPL 64, and are supplied to the anode catalyst layer 66. Likewise, the oxygen containing air supplied to the cathode 60 diffuses in the plane direction of the cathode diffusion layer 68, passes through the cathode MPL 70, and is supplied to the cathode catalyst layer 72.

As described above, in the fuel supply apparatus of this embodiment, by simply connecting the fuel cartridge to the built-in tank of the device, the fuel can be supplied continuously by gravity. When the level of the liquid fuel in the built-in tank of the device rises to a predetermined position, the supply of the fuel is automatically stopped. If the level of the liquid fuel lowers due to consumption of the fuel, the supply of the fuel is automatically resumed. Therefore, the fuel can be supplied continuously without pressing the fuel cartridge with the hand. As such, the convenience for users is dramatically improved.

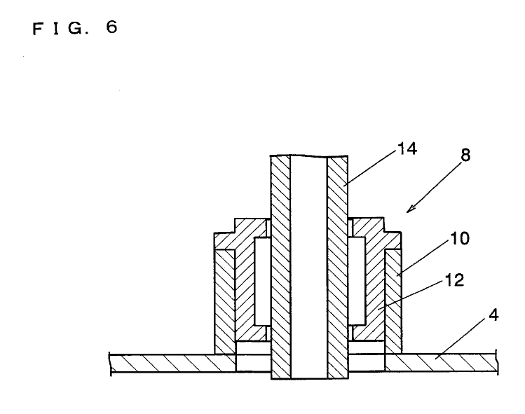

In the above embodiments, both the connector 8 and the connector 10 have a double tube structure, but the invention is not limited to the above embodiments. As illustrated in FIG. 6, for example, it is also possible to provide only the connector 8 with a double tube structure, while providing the connector 10 with a single tube structure. Alternatively, it is also possible to provide only the connector 10 with a double tube structure, while providing the connector 8 with a single tube structure.

The fuel supply apparatus of the invention is highly convenient for users, since there is no need to press the fuel cartridge with the hand, and the fuel can be supplied continuously by gravity. Therefore, even devices having fuel cells which consume relatively large amounts of fuel can be operated continuously for a long time.

Although the invention has been described in terms of the presently preferred embodiments, it is to be understood that such disclosure is not to be interpreted as limiting. Various alterations and modifications will no doubt become apparent to those skilled in the art to which the invention pertains, after having read the above disclosure. Accordingly, it is intended that the appended claims be interpreted as covering all alterations and modifications as fall within the true spirit and scope of the invention.

1. A fuel supply apparatus for supplying a liquid fuel to a device having a fuel cell which uses the liquid fuel, comprising:
a container containing the liquid fuel and being configured to be detachably attached to the device; and
a joint for connecting the container and the device,
wherein the joint has a double tube structure including an outer tube and an inner tube, and
one of the outer tube and the inner tube forms a flow path through which the liquid fuel in the container flows into the device by gravity, while the other tube forms a flow path through which a replacement fluid spontaneously flows into the container to replace the liquid fuel.

2. The fuel supply apparatus in accordance with claim 1, wherein the outer tube forms the flow path for the liquid fuel, while the inner tube forms the flow path for the replacement fluid.

3. The fuel supply apparatus in accordance with claim 1, wherein the smallest inner diameter of the outer tube is 5 to 15 mm, and the smallest inner diameter of the inner tube is 2 to 4 mm.

4. The fuel supply apparatus in accordance with claim 1, wherein the smallest difference between the inner diameter of the outer tube and the outer diameter of the inner tube is 1 to 5 mm.

5. The fuel supply apparatus in accordance with claim 1, wherein the joint has a first connector for the container and a second connector for the device, and each of the outer tube and the inner tube is divided between the first connector and the second connector.

6. The fuel supply apparatus in accordance with claim 5, wherein the inner tube of the first connector is movable in the axial direction thereof relative to the outer tube, and the first connector has a first valve mechanism that opens and closes the outer tube of the first connector by movement of the inner tube.

7. The fuel supply apparatus in accordance with claim 5, wherein the first connector further includes a second valve mechanism including a first valve rod that is inserted in the inner tube in such a manner that the first valve rod is movable in the axial direction of the inner tube, and the second valve mechanism opens and closes the inner tube of the first connector by movement of the first valve rod.

8. The fuel supply apparatus in accordance with claim 5, wherein the inner tube of the second connector is movable in the axial direction thereof relative to the outer tube, and the second connector has a third valve mechanism that opens and closes the outer tube of the second connector by movement of the inner tube.

9. The fuel supply apparatus in accordance with claim 5, wherein the second connector further includes a fourth valve mechanism including a second valve rod that is inserted in the inner tube in such a manner that the second valve rod is movable in the axial direction of the inner tube, and the fourth valve mechanism opens and closes the inner tube of the second connector by movement of the second valve rod.

10. The fuel supply apparatus in accordance with claim 2, wherein when the first connector and the second connector are joined, an inlet of the inner tube of the second connector for the replacement fluid protrudes from an outlet of the outer tube of the second connector for the liquid fuel.

11. A fuel cartridge configured to be detachably attached to a device having a fuel cell which uses a liquid fuel, comprising:
a container containing the liquid fuel; and
a connector for connecting the container to the device,
wherein the connector has a double tube structure including an outer tube and an inner tube, and
one of the outer tube and the inner tube forms a flow path through which the liquid fuel in the container flows into the device by gravity, while the other tube forms a flow path through which a replacement fluid spontaneously flows into the container to replace the liquid fuel.

12. A device comprising:
a fuel cell which uses a liquid fuel;
a fuel tank connected to the fuel cell; and
a connector for connecting the fuel tank to a fuel cartridge containing the liquid fuel,
wherein the connector has a double tube structure including an outer tube and an inner tube, and
one of the outer tube and the inner tube forms a flow path through which the liquid fuel in the fuel cartridge flows into the fuel tank by gravity, while the other tube forms a flow path through which a replacement fluid spontaneously flows into the fuel cartridge to replace the liquid fuel.

13. A joint for connecting a device having a fuel cell which uses a liquid fuel and a fuel cartridge containing the liquid fuel,
the joint having a double tube structure including an outer tube and an inner tube,
wherein one of the outer tube and the inner tube forms a flow path through which the liquid fuel in the fuel cartridge flows into the device by gravity, while the other tube forms a flow path through which a replacement fluid spontaneously flows into the fuel cartridge to replace the liquid fuel.
